(19) United States
(12) Patent Application Publication
(10) Pub. No.: US 2026/0156173 A1
(43) Pub. Date: Jun. 4, 2026

(54) METHOD

(71) Applicant: SEIKO EPSON CORPORATION, Tokyo (JP)

(72) Inventors: Jun ISHIDA, SAPPORO-SHI (JP); Ikuto KANBARA, MATSUMOTO-SHI (JP)

(21) Appl. No.: 19/400,732

(22) Filed: Nov. 25, 2025

(30) Foreign Application Priority Data
Nov. 29, 2024 (JP) 2024-208140

(51) Int. Cl. H04L 67/025

(52) U.S. Cl. CPC H04L 67/025

(57) ABSTRACT

A method according to an aspect includes communicatively connecting to a projection device, causing an application program to transmit a control signal for controlling the projection device to the projection device via a signal communication path, and causing a web browser extension program functioning on a web browser to acquire output data including at least one of video data and audio data.

The present application is based on, and claims priority from JP Application Serial Number 2024-208140, filed November 29, 2024, the disclosure of which is hereby incorporated by reference herein in its entirety.

### BACKGROUND

### 1. Technical Field

The present disclosure relates to a method.

### 2. Related Art

A system including a display device and a controller is known. A system described in JP-A-2022-140564 includes a projector that is an example of a display device and an information processing device that is an example of a controller. The projector and the information processing device are communicably connected via a network. The projector receives image data and the like from the information processing device and projects the image data. The information processing device operates on an operating system such as Windows, Android, or iOS. Windows, Android, and iOS are respectively registered trademarks.

JP-A-2022-140564 is an example of the related art.

Depending on a model of the information processing device or a type of the operating system operating on the information processing device, deficiencies sometimes occur when image data is output to an external device such as a projector.

### SUMMARY

A method according to an aspect of the present disclosure includes: communicatively connecting to a projection device; causing an application program to transmit a control signal for controlling the projection device to the projection device via a signal communication path; and causing a web browser extension program functioning on a web browser to acquire output data including at least one of video data and audio data.

### BRIEF DESCRIPTION OF THE DRAWINGS

FIG. 1 is a diagram illustrating a schematic configuration of a system.

FIG. 2 is a diagram illustrating a block configuration of the system.

FIG. 3 is a diagram illustrating a schematic configuration of a projector.

FIG. 4 is a diagram illustrating a system configuration of the system.

FIG. 5 is a diagram illustrating an example of a display screen.

FIG. 6 is a diagram illustrating a control flow executed by a controller.

FIG. 7 is a diagram illustrating a control flow executed by the controller.

FIG. 8 is a diagram illustrating an example of an installation instruction image.

FIG. 9 is a diagram illustrating an example of an acquisition instruction image.

FIG. 10 is a diagram illustrating a system configuration of the system.

FIG. 11 is a diagram illustrating a control flow executed by the controller.

### DESCRIPTION OF EMBODIMENTS

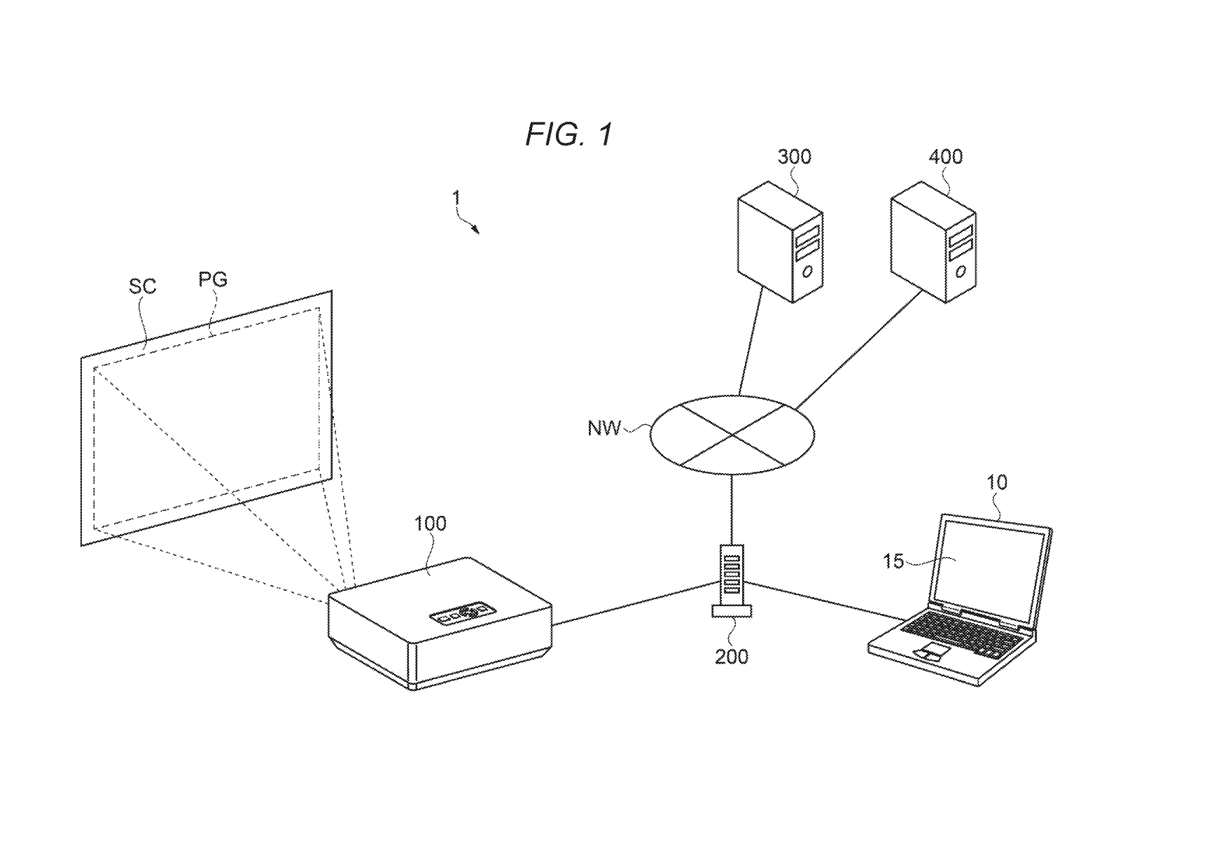

FIG. 1 illustrates a schematic configuration of a system 1. The system 1 includes a controller 10, a projection system 100, a router 200, an application providing server 300, and a web server 400. The projection system 100 projects a projection image PG onto a projection surface SC. The application providing server 300 and the web server 400 are communicably connected to the controller 10 via a communication network NW. The system 1 illustrated in FIG. 1 includes one controller 10 and one projection system 100 but is not limited thereto. The system 1 may include a plurality of controllers 10 and a plurality of projection systems 100.

The controller 10 is communicably connected to the projection system 100. The controller 10 transmits projection image data to the projection system 100. The controller 10 executes mirroring for causing the projection system 100 to project a display screen DS displayed on a display 15 of the controller 10. The controller 10 may have a function of adjusting an image shape and the like of the projection image PG projected onto the projection surface SC by the projection system 100. The controller 10 is a tablet terminal, a mobile computer, a desktop personal computer, or the like. FIG. 1 illustrates, as the controller 10, a mobile computer including the display 15. The controller 10 corresponds to an example of an information processing device.

The controller 10 executes various programs such as a web browser 80 on a dedicated operating system 70. The dedicated operating system 70 is, for example, a Chrome OS. Chrome is a registered trademark. The dedicated operating system 70 can construct a virtual environment. In the virtual environment, a program operable on an operating system different from the dedicated operating system 70 is operable on the dedicated operating system 70. The operating system different from the dedicated operating system 70 is, for example, an Android OS. The program operable on the operating system different from the dedicated operating system 70 is, for example, an Android application.

The display 15 displays screens including various videos and various images. The display 15 includes a liquid crystal panel or an organic electro-luminescence (EL) panel. The display 15 may have a touch input function of receiving input operation by a user.

The projection system 100 is disposed at a position facing the projection surface SC. The projection system 100 is communicably connected to the controller 10. The projection system 100 corresponds to an example of a projection device. The projection system 100 may be communicably connected to an external device different from the controller 10. The projection system 100 receives projection image data from the controller 10. The projection system 100 projects the projection image PG onto the projection surface SC based on the projection image data. The projection system 100 may execute mirroring of the display screen DS displayed on the display 15 of the controller 10 based on the projection image data. The projection system 100 may project the projection image PG onto the projection surface SC based on OSD data stored in advance. OSD is an abbreviation for on-screen display.

The projection surface SC displays the projection image PG projected from the projection system 100. The projection surface SC illustrated in FIG. 1 includes a screen but is not limited thereto. The projection surface SC may be an indoor wall, a ceiling, an outer wall of a building, or the like. A surface shape of the projection surface SC is not limited to a flat surface and may be a three-dimensional shape such as a curved surface, an uneven surface, or a spherical surface.

The router 200 is communication equipment that connects the controller 10, the projection system 100, the application providing server 300, and the web server 400 to one another. The router 200 communicably connects the controller 10 and the application providing server 300 via the communication network NW. The router 200 communicably connects the controller 10 and the web server 400 via the communication network NW. The router 200 communicably connects the controller 10 and the projection system 100 using a predetermined communication protocol. The router 200 may communicatively connect the projection system 100 and the web server 400. The controller 10 and the projection system 100 may be directly communicatively connected not via the router 200.

The communication network NW is a line network that communicatively connects the application providing server 300, the web server 400, and the controller 10. The communication network NW is, for example, a wide area network (WAN).

The application providing server 300 provides various applications, a function extension application added to the web browser 80, and the like to the controller 10. The application providing server 300 is managed by, for example, a system provider that provides the dedicated operating system 70. The application providing server 300 may include a cloud server.

The web server 400 provides display of an HTML and an object to the web browser 80 of client software. The web server 400 may provide a web application to the web browser 80 of the controller 10 based on an instruction from the controller 10. The web server 400 is managed by an application provider that provides, for example, a projection application 91 explained below.

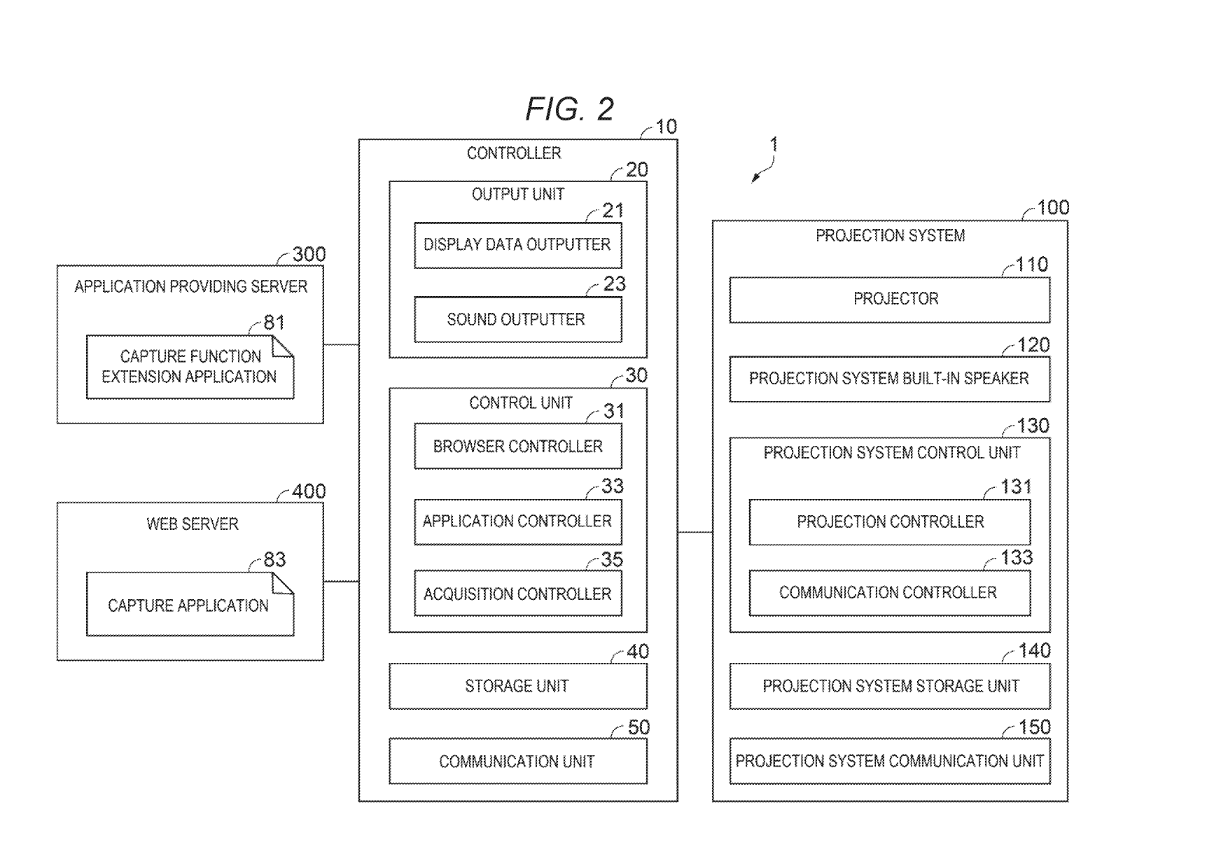

FIG. 2 illustrates a block configuration of the system 1. FIG. 2 illustrates block configurations of the controller 10, the projection system 100, the application providing server 300, and the web server 400 provided in the system 1. FIG. 2 illustrates the system 1 in which the router 200 is omitted.

The controller 10 includes a display 15, an output unit 20, a control unit 30, a storage unit 40, and a communication unit 50. The display 15 is not illustrated in FIG. 2. The controller 10 may include a not-illustrated input unit.

The output unit 20 outputs various kinds of generation data generated by the control unit 30 to the display 15 and the like. The output unit 20 includes various circuits and an output terminal. The output unit 20 corresponds to an example of an outputter. The output unit 20 includes a display data outputter 21 and a sound outputter 23.

The display data outputter 21 outputs video data for displaying a video to the display 15. The video data includes image data for displaying a still image. The video data is included in generation data. The display data outputter 21 may output the video data to a display device externally attached to the controller 10.

The sound outputter 23 outputs audio data relating to sound. The audio data is included in the generation data. The sound outputter 23 is coupled to a not-illustrated speaker and the like. The speaker and the like may be built in the controller 10 or may be externally attached to the controller 10. The sound outputter 23 outputs the audio data by wire or radio.

The control unit 30 is a device controller that controls the units of the controller 10. The control unit 30 is, for example, a processor including a central processing unit (CPU). The control unit 30 includes one or a plurality of processors. In the control unit 30, the dedicated operating system 70 operates. The control unit 30 executes various programs on the dedicated operating system 70. The control unit 30 functions as various functional units by executing a device control program. As an example, the control unit 30 functions as a browser controller 31, an application controller 33, and an acquisition controller 35. The control unit 30 may function as functional units other than the browser controller 31, the application controller 33, and the acquisition controller 35.

The browser controller 31 causes the web browser 80 to operate on the dedicated operating system 70 to display a web page or the like. The browser controller 31 acquires a function extension application and extends a function of the web browser 80 by causing the function extension application to operate. The browser controller 31 may cause the web application to operate on the web browser 80 to execute a function of the web application. As an example, the browser controller 31 causes a capture function extension application 81 explained below to operate to capture at least one of video data and audio data.

The application controller 33 causes an application to operate on the dedicated operating system 70 or on the virtual environment. The application controller 33 causes an application having specifications corresponding to the dedicated operating system 70 to operate on the dedicated operating system 70. The application controller 33 causes an application having specifications different from the specifications corresponding to the dedicated operating system 70 to operate on the virtual environment. The virtual environment includes a virtual device 90 that operates on the dedicated operating system 70. The virtual device 90 is explained below.

The acquisition controller 35 executes various operations when acquiring the function extension application, the web application, and the like. The acquisition controller 35 causes the display 15 to display a message or the like for acquiring the function extension application and the like. The acquisition controller 35 may generate notification voice data for outputting a message or the like by voice. The acquisition controller 35 transmits an acquisition request or the like for requesting acquisition of the function extension application or the like to the application providing server 300 or the like based on various instructions from a user of the controller 10. The acquisition controller 35 causes the control unit 30 to install the function extension application or the like acquired in response to the acquisition request or the like and execute various functions.

The storage unit 40 stores various programs, various data, and the like. The storage unit 40 stores a device control program, various function extension applications, various web applications, various applications, and the like. The storage unit 40 stores various data and the like generated by the control unit 30. The storage unit 40 includes a volatile semiconductor memory such as a random access memory (RAM) and a nonvolatile memory such as a read only memory (ROM) or a flash memory. The storage unit 40 may function as a work area of the control unit 30. The storage unit 40 corresponds to an example of a storage.

The communication unit 50 is a communication interface circuit that communicates with the projection system 100, the application providing server 300, and the like. The communication unit 50 is wirelessly connected to the projection system 100 and the like according to a predetermined communication protocol. The communication unit 50 includes a wireless communication port. The wireless communication port is a wireless local area network (LAN) communication port or the like. The communication unit 50 may be connected to the projection system 100 and the like by wire. The communication unit 50 includes a wired connector such as a universal serial bus (USB). The communication unit 50 transmits projection image data and the like to the projection system 100 and the like. The projection image data includes video data, audio data, and the like. The communication unit 50 receives various data from the application providing server 300 and the like.

The projection system 100 includes a projector 110, a projection system built-in speaker 120, a projection system control unit 130, a projection system storage unit 140, and a projection system communication unit 150.

The projector 110 enlarges image light based on the projection image data and projects the image light onto the projection surface SC. The projector 110 projects the projection image PG onto the projection surface SC based on control of the projection system control unit 130. The projector 110 projects a moving image, a still image, an OSD image, or the like as the projection image PG based on the video data included in the projection image data. The OSD image is an image showing various kinds of setting, operation information, and the like relating to the projection system 100.

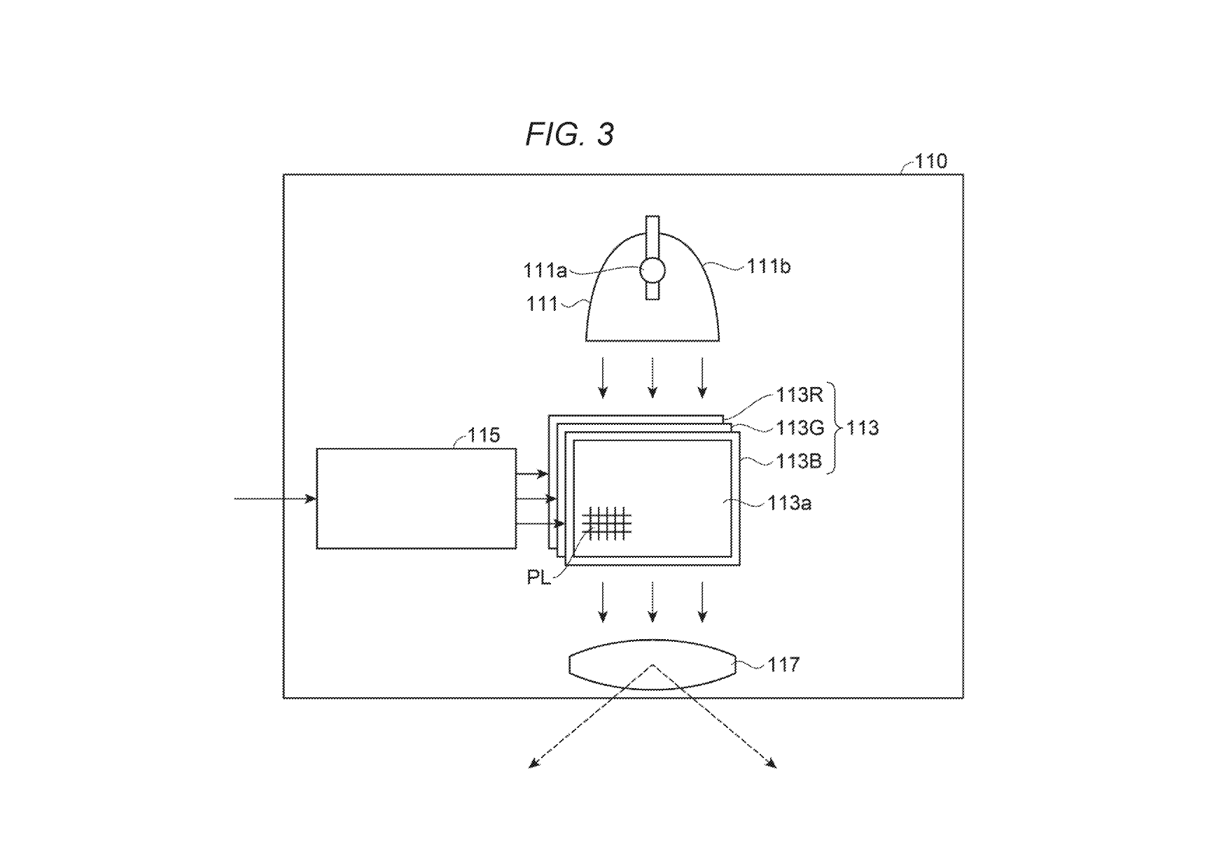

FIG. 3 illustrates a schematic configuration of the projector 110. FIG. 3 illustrates an example of the projector 110. The projector 110 includes a light source 111, three liquid crystal light valves 113, a light valve driver 115, and a projection lens 117.

The light source 111 emits light to the liquid crystal light valves 113. The light source 111 includes a light source unit 111a, a reflector 111b, a not-illustrated integrator optical system, and a not-illustrated color separation optical system. The light source unit 111a emits light. The light source unit 111a includes a xenon lamp, an ultra-high pressure mercury lamp, a light emitting diode (LED), or a laser light source. The light source unit 111a emits light based on the control of the projection system control unit 130. The reflector 111b reduces variation in an emission direction of the light emitted by the light source unit 111a. The integrator optical system reduces variation in a luminance distribution of the light emitted by the light source unit 111a. The light having passed through the reflector 111b is made incident on the color separation optical system. The color separation optical system separates the incident light into red, green, and blue color light components.

The liquid crystal light valve 113 modulates light emitted from the light source 111. The liquid crystal light valve 113 modulates the light to thereby generate the projection image PG and the like. The liquid crystal light valve 113 includes a transmissive liquid crystal panel in which liquid crystal is encapsulated between a pair of transparent substrates. The liquid crystal light valve 113 has a rectangular pixel region 113a including a plurality of pixels PL arrayed in a matrix. In the liquid crystal light valve 113, a drive voltage is applied to the liquid crystal for each of the pixels PL. The projection system 100 illustrated in FIG. 3 includes the three liquid crystal light valves 113. The projection system 100 uses the transmissive liquid crystal panel provided in the liquid crystal light valve 113 but is not limited thereto. The projection system 100 may include a reflective liquid crystal panel or an LCOS (liquid crystal on silicon) liquid crystal panel. The projection system 100 may include one or more digital mirror devices (DMDs).

The three liquid crystal light valves 113 are a liquid crystal light valve for red light 113R, a liquid crystal light valve for green light 113G, and a liquid crystal light valve for blue light 113B. A red color light component separated by the color separation optical system is made incident on the liquid crystal light valve for red light 113R. A green color light component separated by the color separation optical system is made incident on the liquid crystal light valve for green light 113G. A blue color light component separated by the color separation optical system is made incident on the liquid crystal light valve for blue light 113B.

The light valve driver 115 applies a drive voltage to the pixels PL based on projection image data received from the projection system control unit 130. The light valve driver 115 is, for example, a control circuit. The drive voltage is supplied by a not-illustrated drive source. The light valve driver 115 may apply the drive voltage to the pixels PL based on projection image data corrected by a projection controller 131 explained below. When the light valve driver 115 applies the drive voltage to the pixels PL, the pixels PL are set to a light transmittance based on the projection image data. The light emitted from the light source 111 is modulated by being transmitted through the pixel region 113a. The three liquid crystal light valves 113 form color component images for each color light.

The projection lens 117 combines the color component images formed by the liquid crystal light valves 113 and enlarges and projects a combined image. The projection lens 117 projects the projection image PG onto the projection surface SC. The projection image PG is a multi-color image obtained by combining the color component images.

The projection system built-in speaker 120 illustrated in FIG. 2 outputs sound based on the audio data included in the projection image data. The projection system built-in speaker 120 receives the audio data from the projection system control unit 130 and outputs sound corresponding to the audio data. The projection system 100 illustrated in FIG. 2 includes the projection system built-in speaker 120 but is not limited thereto. The projection system 100 may include an external speaker. The external speaker outputs sound based on audio data.

The projection system control unit 130 is a projection system control controller that controls the units of the projection system 100. The projection system control unit 130 is, for example, a processor including a CPU. The projection system control unit 130 includes one or a plurality of processors. The projection system control unit 130 functions as a projection controller 131 and a communication controller 133 by executing firmware. The projection system control unit 130 may function as a functional unit other than the projection controller 131 and the communication controller 133.

The projection controller 131 controls projection by the projector 110. The projection controller 131 causes the projector 110 to project the projection image PG based on the video data included in the projection image data transmitted from the controller 10. The projection controller 131 causes the projection system built-in speaker 120 to output sound based on the audio data included in the projection image data. The projection controller 131 synchronizes the projection image PG projected from the projector 110 with the sound output from the projection system built-in speaker 120. The projection controller 131 performs various kinds of correction processing such as trapezoidal correction on the video data.

The communication controller 133 controls communication with the controller 10. The communication controller 133 causes the projection system communication unit 150 to execute various kinds of communication. The communication controller 133 controls communication according to a function of the projection system communication unit 150.

The projection system storage unit 140 stores firmware, various data, and the like. The projection system storage unit 140 stores the projection image data transmitted from the controller 10, correction data for correcting the video data included in the projection image data, and the like. The projection system storage unit 140 includes a volatile semiconductor memory such as a RAM and a nonvolatile memory such as a ROM or a flash memory.

The projection system communication unit 150 is a communication interface circuit that communicates with the controller 10, an external device, and the like. The projection system communication unit 150 is connected to the controller 10 and the like by radio according to a predetermined communication protocol. The projection system communication unit 150 may or may not include a functional unit that performs communication using the Web Real-Time Communication (WebRTC) technology. The projection system communication unit 150 includes a wireless communication port. The wireless communication port is a wireless LAN communication port or the like. The projection system communication unit 150 may be connected to the controller 10 and the like by wire. The projection system communication unit 150 includes a wired connector such as a USB. The projection system communication unit 150 receives the projection image data from the controller 10. The projection system communication unit 150 transmits various data such as projection system setting information to the controller 10 and the like.

The application providing server 300 stores a plurality of function extension applications, a plurality of dedicated operating system applications, and the like. The plurality of function extension applications include the capture function extension application 81. The capture function extension application 81 functions on the web browser 80. The capture function extension application 81 captures, as capture data, the generation data output from the output unit 20. The generation data includes at least one of the video data output from the display data outputter 21 and the audio data output from the sound outputter 23. The capture function extension application 81 executes, on the web browser 80, a function of acquiring the generation data. The capture function extension application 81 corresponds to an example of a web browser extension program.

The web server 400 stores a plurality of web applications. The plurality of web applications include a capture application 83. The capture application 83 operates on the web browser 80. The capture application 83 captures, as capture data, the generation data output from the output unit 20. The capture application 83 has the same function as the function of the capture function extension application 81. The capture application 83 transmits, for example, generation data acquired in WebSocket communication processing. The capture application 83 corresponds to an example of a web application program.

### First embodiment

In a first embodiment, a first system 1a, which is an example of the system 1, is explained. The first system 1a includes a first projection system 100a including a stream communicator 151 that performs communication using the WebRTC technology. The first projection system 100a is an example of the projection system 100.

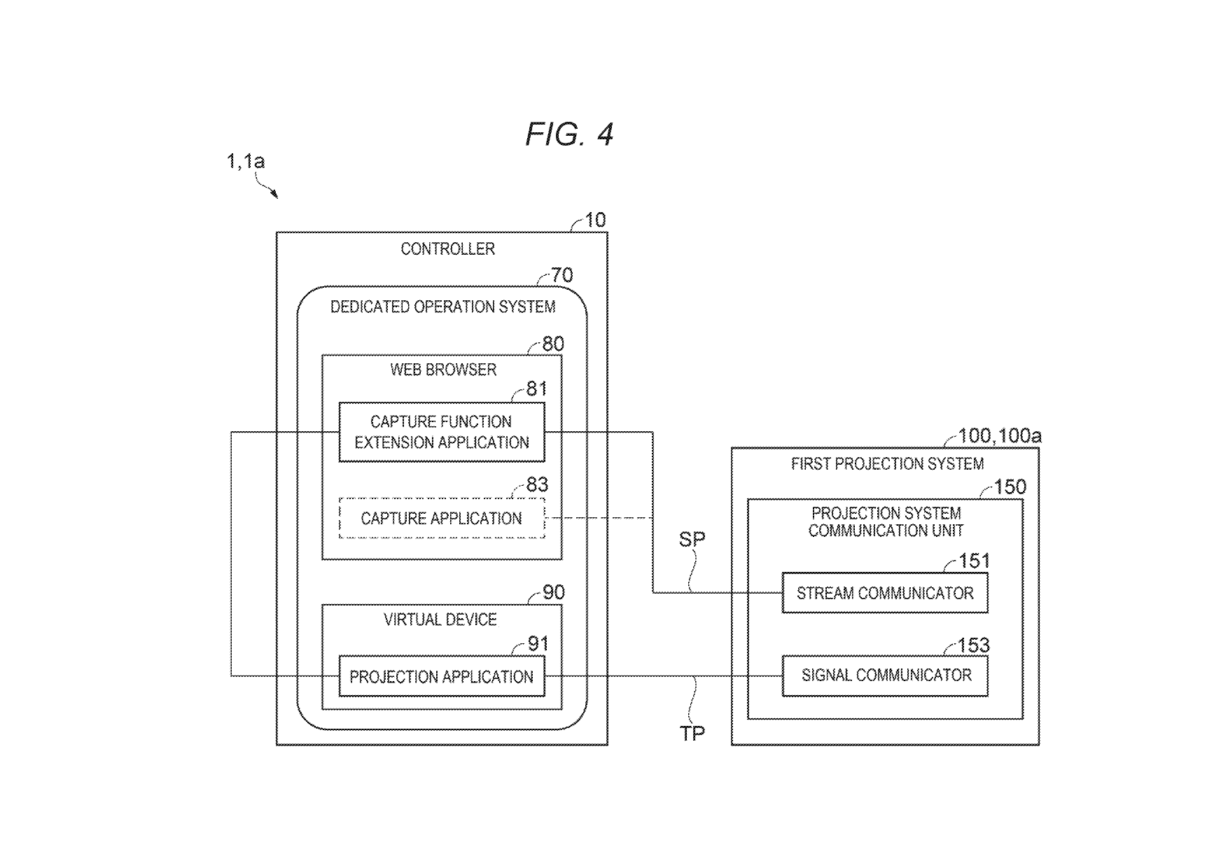

FIG. 4 illustrates a system configuration of the system 1. FIG. 4 schematically illustrates a system configuration of the first system 1a, which is an example of the system 1. FIG. 4 illustrates the controller 10 and the first projection system 100a.

In the controller 10, the dedicated operating system 70 operates. In the first embodiment, the dedicated operating system 70 is a Chrome OS. The control unit 30 of the controller 10 causes the dedicated operating system 70 to operate. An application corresponding to the dedicated operating system 70 is operable on the dedicated operating system 70. The web browser 80 and the virtual device 90 operate on the dedicated operating system 70 illustrated in FIG. 4. An application other than the web browser 80 and the virtual device 90 may operate on the dedicated operating system 70.

The web browser 80 is software that displays various web pages. The web browser 80 is connected to the web server 400 and the like. The web browser 80 operates on the dedicated operating system 70. The web browser 80 is, for example, Chrome. The web browser 80 starts various function extension applications and various web applications. The web browser 80 illustrated in FIG. 4 can cause the capture function extension application 81 to operate. The web browser 80 may cause the capture application 83 to operate.

The capture function extension application 81 starts on the web browser 80. The controller 10 acquires the capture function extension application 81 from the application providing server 300 and causes the storage unit 40 to store the capture function extension application 81. The web browser 80 causes the capture function extension application 81 to operate based on an operation request from another application. The capture function extension application 81 captures, as capture data, generation data output from the output unit 20 of the controller 10. The capture function extension application 81 transmits the capture data to the first projection system 100a through a stream distribution path SP as shared data. The shared data includes at least one of video data and audio data. The shared data corresponds to an example of output data. The capture function extension application 81 may transmit the capture data to the projection application 91.

The capture application 83 starts on the web browser 80. The controller 10 acquires the capture application 83 from the web server 400 and causes the storage unit 40 to store the capture application 83. The web browser 80 causes the capture application 83 to operate based on a web application operation request from another application. The capture application 83 captures, as capture data, generation data output from the output unit 20 of the controller 10. The capture application 83 transmits the capture data to the first projection system 100a through the stream distribution path SP as shared data. The capture application 83 may transmit the capture data to the projection application 91.

The virtual device 90 is a virtual device that operates on the dedicated operating system 70. The virtual device 90 is an example of an emulator that operates on the dedicated operating system 70. The virtual device 90 functions as a device that causes an operating system different from the dedicated operating system 70 to operate on the dedicated operating system 70. The virtual device 90 provides a virtual environment on the dedicated operating system 70. The virtual device 90 is, for example, a device in which an Android OS operates. An application operating on the operating system different from the dedicated operating system 70 is capable of starting on the virtual device 90. The application operating on the operating system different from the dedicated operating system 70 is an Android application. The projection application 91 illustrated in FIG. 4 is an example of the Android application.

The projection application 91 is software that controls the projection system 100 including the first projection system 100a. The projection application 91 is stored in the storage unit 40 in advance. The projection application 91 illustrated in FIG. 4 causes the first projection system 100a to project various projection images PG. The projection application 91 transmits various control signals to the first projection system 100a. The projection application 91 causes the capture function extension application 81 to operate on the web browser 80. The projection application 91 may cause the capture application 83 to operate on the web browser 80. The projection application 91 causes the capture function extension application 81 and the like to operate and causes the web browser 80 to acquire shared data. The projection application 91 transmits the shared data to the first projection system 100a. The projection application 91 receives various response signals and the like from the first projection system 100a. The projection application 91 corresponds to an example of an application program.

The projection application 91 operating on the virtual device 90 transmits or receives various control signals and the like to and from the dedicated operating system 70 via various application programming interfaces (APIs). The API is different depending on a version or the like of an operating system operating on the virtual device 90. Depending on the version of the operating system operating on the virtual device 90, it is sometimes difficult for the projection application 91 to control the first projection system 100a. The projection application 91 acquires shared data using the function of the web browser 80.

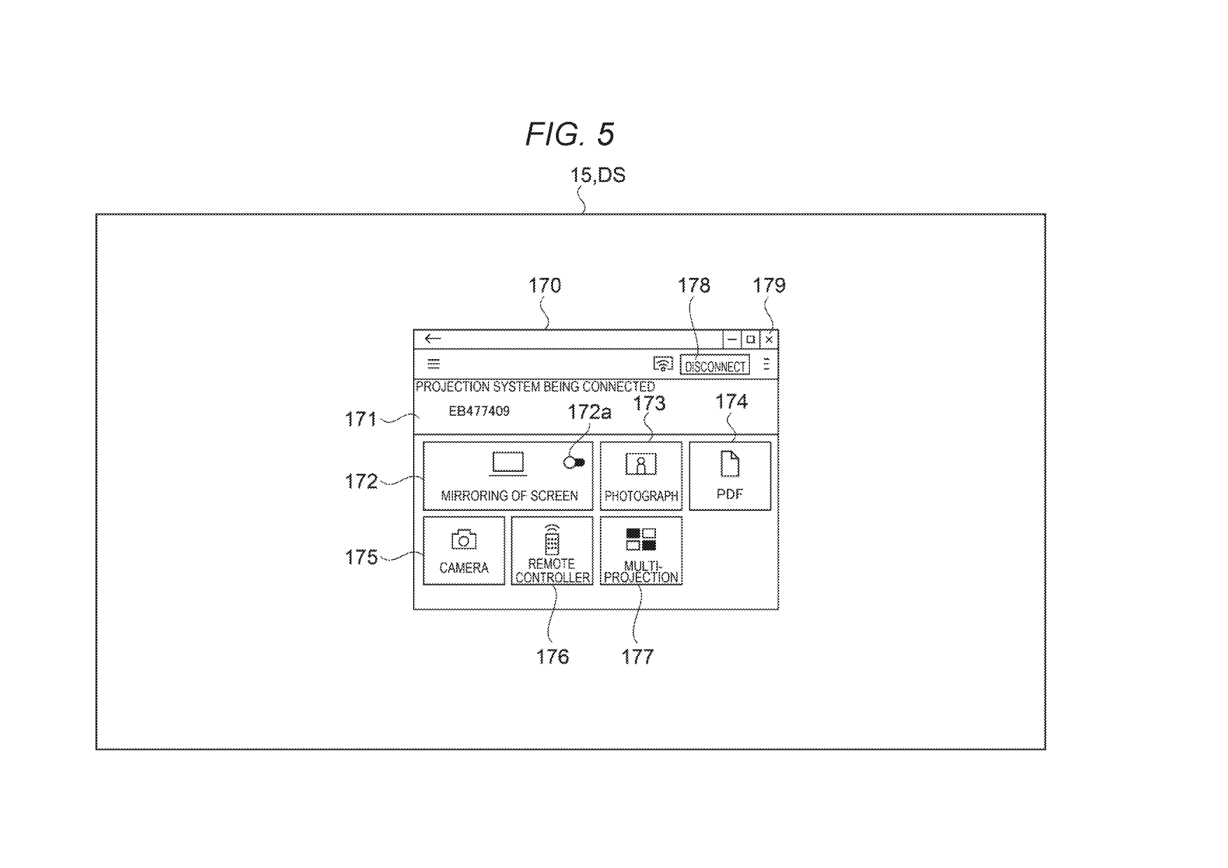

FIG. 5 illustrates an example of the display screen DS. The display screen DS is displayed on the display 15. The display screen DS illustrated in FIG. 5 indicates the display screen DS at the time when the controller 10 starts the projection application 91. The display screen DS includes a UI screen 170 of the projection application 91. UI is an abbreviation for a user interface.

The UI screen 170 displays a plurality of icons and the like. The UI screen 170 includes a projection system name display section 171, a mirroring reception icon 172, a photograph display reception icon 173, a document display reception icon 174, a camera image display reception icon 175, a remote controller function reception icon 176, a multi-projection reception icon 177, a disconnection reception icon 178, and an end reception icon 179.

The projection system name display section 171 displays a projection system name of the first projection system 100a coupled to the controller 10. The projection system name display section 171 displays a projection system name included in model information of the first projection system 100a acquired from the first projection system 100a.

The mirroring reception icon 172 receives a mirroring instruction by the user. When the user executes predetermined operation on the mirroring reception icon 172, the mirroring reception icon 172 receives the mirroring instruction. When receiving the mirroring instruction, the projection application 91 generates a mirroring control signal corresponding to the mirroring instruction. The mirroring reception icon 172 includes a switch icon 172a.

The switch icon 172a indicates whether the first projection system 100a is executing mirroring. By checking the display of the switch icon 172a, the user can discriminate whether the first projection system 100a is executing mirroring. The switch icon 172a may receive the mirroring instruction by the user.

The photograph display reception icon 173 receives a photograph display instruction by the user. When the user executes predetermined operation on the photograph display reception icon 173, the photograph display reception icon 173 receives the photograph display instruction. When receiving the photograph display instruction, the projection application 91 performs photograph display processing of causing the first projection system 100a to project a photograph image stored by the controller 10. The projection application 91 transmits photograph image data for displaying the photograph image to the first projection system 100a and causes the first projection system 100a to project the photograph image as the projection image PG.

The document display reception icon 174 receives a document display instruction by the user. When the user executes predetermined operation on the document display reception icon 174, the document display reception icon 174 receives the document display instruction. When receiving the document display instruction, the projection application 91 performs document display processing of causing the first projection system 100a to project a PDF file or the like stored by the controller 10. The projection application 91 transmits, for example, PDF data for displaying a PDF image to the first projection system 100a and causes the first projection system 100a to project the PDF image as the projection image PG.

The camera image display reception icon 175 receives a camera image display instruction by the user. When the controller 10 includes an imaging device such as a camera, the camera image display reception icon 175 can be operated. When the user executes predetermined operation on the camera image display reception icon 175, the camera image display reception icon 175 receives the camera image display instruction. When receiving the camera image display instruction, the projection application 91 performs camera image display processing of causing the first projection system 100a to project a captured image captured by the imaging device. The projection application 91 transmits imaging data for displaying the captured image to the first projection system 100a and causes the first projection system 100a to project the captured image as the projection image PG.

The remote controller function reception icon 176 receives a remote controller function operation instruction by the user. When the user executes predetermined operation on the remote controller function reception icon 176, the remote controller function reception icon 176 receives the remote controller function operation instruction. When receiving the remote controller function operation instruction, the projection application 91 displays a remote controller image indicating a remote controller for operating the first projection system 100a on the projection image PG. The user can control the first projection system 100a by performing input operation on the remote controller image.

The multi-projection reception icon 177 receives a multi-projection instruction by the user. The multi-projection reception icon 177 can be operated when the plurality of projection systems 100 including the first projection system 100a are coupled to the controller 10. When the user executes predetermined operation on the multi-projection reception icon 177, the multi-projection reception icon 177 receives the multi-projection instruction. The projection application 91 executes multi-projection for causing the plurality of projection systems 100 coupled to the controller 10 to project the projection image PG onto the projection surface SC.

The disconnection reception icon 178 receives a disconnection instruction by the user. When the user executes predetermined operation on the disconnection reception icon 178, the disconnection reception icon 178 receives the disconnection instruction. When receiving the disconnection instruction, the projection application 91 disconnects the communication connection between the controller 10 and the first projection system 100a.

The end reception icon 179 receives an end instruction by the user. When the user performs predetermined operation on the end reception icon 179, the end reception icon 179 receives the end instruction. When receiving the end instruction, the projection application 91 stops operating. The projection application 91 hides the UI screen 170.

The stream distribution path SP illustrated in FIG. 4 is a path for performing real-time communication between the web browser 80 and the first projection system 100a. The stream distribution path SP performs communication using, for example, a WebRTC technology. When the first projection system 100a includes the projection system communication unit 150 adapted to the WebRTC technology, the web browser 80 can transmit shared data to the first projection system 100a through the stream distribution path SP. Since the web browser 80 transmits the shared data to the first projection system 100a through the stream distribution path SP, the controller 10 can transmit the shared data to the first projection system 100a without deteriorating the quality of the shared data. The stream distribution path SP corresponds to an example of a browser communication path.

A TCP/IP communication path TP is a path for performing communication using a TCP/IP (Transmission Control Protocol/Internet Protocol). The TCP/IP communication path TP and the stream distribution path SP are communication paths different from each other. The projection application 91 transmits various control signals to the first projection system 100a via the TCP/IP communication path TP. The projection application 91 receives a response signal or the like from the first projection system 100a through the TCP/IP communication path TP. When the first projection system 100a does not include the projection system communication unit 150 adapted to the WebRTC technology, the projection application 91 transmits shared data to the first projection system 100a through the TCP/IP communication path TP. When the shared data is transmitted to the first projection system 100a through the TCP/IP communication path TP, the quality of the shared data is likely to be deteriorated depending on a situation of the virtual device 90. The shared data is preferably transmitted to the first projection system 100a through the stream distribution path SP. The TCP/IP communication path TP corresponds to an example of a signal communication path.

The projection system communication unit 150 of the first projection system 100a includes a stream communicator 151 and a signal communicator 153. The projection system communication unit 150 illustrated in FIG. 4 is adapted to the WebRTC technology.

The stream communicator 151 is a communication circuit adapted to the WebRTC technology. The stream communicator 151 is communicatively connected to the capture function extension application 81 through the stream distribution path SP. The stream communicator 151 receives, by real-time communication, shared data transferred from the capture function extension application 81 using the WebRTC technology.

The signal communicator 153 is communicatively connected to the projection application 91 through the TCP/IP communication path TP. The signal communicator 153 receives a control signal from the projection application 91. The signal communicator 153 transmits a response signal or the like generated by the first projection system 100a to the projection application 91. Since the signal communicator 153 transmits and receives the control signal and the like between the projection application 91 and the first projection system 100a, the projection application 91 can control the first projection system 100a.

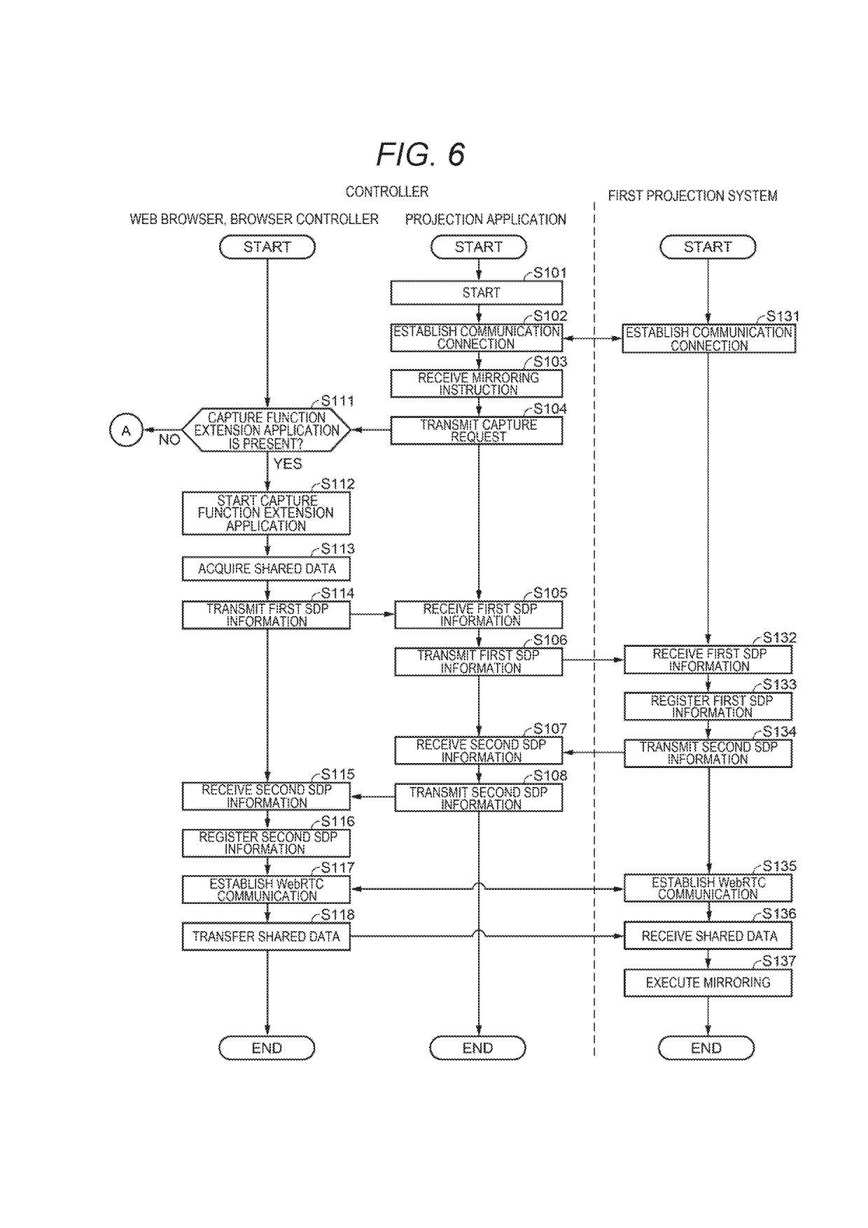

FIG. 6 illustrates a control flow executed by the system 1. FIG. 6 illustrates a control flow executed by the first system 1a, which is an example of the system 1. FIG. 6 illustrates control flows executed by the controller 10 and the first projection system 100a. The control flow executed by the controller 10 corresponds to an example of an information processing method. The controller 10 executes the control flow to thereby execute mirroring for causing the first projection system 100a to project the display screen DS displayed on the display 15.

In step S101, the controller 10 starts the projection application 91. When receiving predetermined operation by the user, the controller 10 starts the projection application 91. The projection application 91 starts on the virtual device 90. The projection application 91 is executed on a virtual environment.

After starting the projection application 91, the controller 10 establishes communication connection to the first projection system 100a in step S102. The projection application 91 transmits a control signal such as a connection request to the first projection system 100a through the TCP/IP communication path TP and establishes communication connection to the first projection system 100a.

After the projection application 91 is started, the first projection system 100a establishes communication connection to the projection application 91 in step S131. The first projection system 100a receives a control signal such as a connection request from the projection application 91 through the TCP/IP communication path TP. The first projection system 100a transmits various data such as model information and establishes communication connection to the projection application 91. When the communication connection to the projection application 91 is established, the first projection system 100a can receive shared data transferred from the controller 10.

After establishing the communication connection to the first projection system 100a, the controller 10 receives a mirroring instruction in step S103. When started, the projection application 91 causes the display 15 to display the UI screen 170. When the user executes predetermined operation on the mirroring reception icon 172 included in the UI screen 170 displayed on the display 15, the mirroring reception icon 172 receives the mirroring instruction. When receiving the mirroring instruction, the projection application 91 generates various control signals such as a mirroring control signal corresponding to the mirroring instruction.

After receiving the mirroring instruction, the projection application 91 transmits a capture request corresponding to the mirroring instruction to the browser controller 31 in step S104. The browser controller 31 receives the capture request.

After the projection application 91 transmits the mirroring request, in step S111, the browser controller 31 discriminates whether the capture function extension application 81 is stored in the storage unit 40. When discriminating that the capture function extension application 81 is not stored in the storage unit 40, the browser controller 31 proceeds to a process A (S111: NO). The process A is explained below. When discriminating that the capture function extension application 81 is stored in the storage unit 40, the browser controller 31 proceeds to step S112 (S111: YES).

In step S112, the browser controller 31 starts the capture function extension application 81. When receiving the capture request, the browser controller 31 discriminates whether the web browser 80 is started. When the web browser 80 is not started, the browser controller 31 starts the web browser 80. After starting the web browser 80, the browser controller 31 starts the capture function extension application 81. When the capture function extension application 81 is started, the web browser 80 can acquire, with the function of the capture function extension application 81, as shared data, generation data output from the output unit 20.

After executing the capture function extension application 81, the controller 10 acquires the shared data in step S113. The web browser 80 causes the capture function extension application 81 to acquire the shared data. The capture function extension application 81 captures, as capture data, generation data output from the output unit 20 of the controller 10. The generation data includes at least one of the video data output from the display data outputter 21 and the audio data output from the sound outputter 23. The capture data is an example of shared data including at least one of video data and audio data.

When acquiring the shared data, in step S114, the controller 10 transmits first SDP information from the web browser 80 to the projection application 91. When acquiring the first SDP information in step S105, in step S106, the projection application 91 transmits the first SDP information to the projection system 100. When acquiring the first SDP information in step S132, in step S133, the projection system 100 registers the first SDP information in the projection system storage unit 140. In step S134, the projection system 100 transmits second SDP information to the projection application 91. When acquiring the second SDP information in step S107, in step S108, the projection application 91 transmits the second SDP information to the web browser 80. When acquiring the second SDP information in step S115, in step S116, the controller 10 registers the second SDP information in the storage unit 40. In step S117, the web browser 80 establishes WebRTC communication with the projection system 100. In step S135, the projection system 100 establishes WebRTC communication with the web browser 80.

When establishing the WebRTC communication with the projection system 100, in step S118, the controller 10 transfers the shared data to the first projection system 100a. The capture function extension application 81 operating on the web browser 80 transfers the shared data acquired via the stream distribution path SP to the projection system communication unit 150 of the first projection system 100a. The capture function extension application 81 transfers the shared data to the stream communicator 151 of the projection system communication unit 150 in real time through the stream distribution path SP. Since the capture function extension application 81 transfers the shared data to the first projection system 100a via the stream distribution path SP, the controller 10 can transfer the shared data to the first projection system 100a while suppressing deterioration in the quality of the shared data. The projection application 91 can transfer the shared data to the first projection system 100a using the function of the capture function extension application 81.

When the controller 10 transfers the shared data, the first projection system 100a receives the shared data in step S136. The stream communicator 151 of the projection system communication unit 150 receives the shared data via the stream distribution path SP.

After receiving the shared data, the first projection system 100a executes mirroring in step S137. When the video data is included in the shared data, the first projection system 100a acquires the video data included in the shared data. The projection controller 131 of the projection system control unit 130 transmits the video data to the projector 110. The projection controller 131 causes the projector 110 to project the video data. The projector 110 projects the projection image PG based on the video data onto the projection surface SC. When the audio data is included in the shared data, the first projection system 100a acquires the audio data included in the shared data. The projection controller 131 transmits the audio data to the projection system built-in speaker 120. The projection system built-in speaker 120 outputs sound based on the audio data. The first projection system 100a displays, based on the shared data including the video data and the audio data, the display screen DS displayed on the display 15 of the controller 10 and outputs sound based on the audio data. When the shared data is the audio data, the projection controller 131 of the projection system control unit 130 transmits the audio data to the projection system built-in speaker 120. The first projection system 100a outputs sound based on the audio data. The first projection system 100a executes mirroring based on the shared data including one of the video data and the audio data.

The control flow executed by the controller 10 includes communicably connecting to the first projection system 100a, causing the projection application 91 to transmit a control signal for controlling the first projection system 100a to the first projection system 100a via the TCP/IP communication path TP, and causing the capture function extension application 81 functioning on the web browser 80 to acquire shared data including at least one of video data and audio data.

By acquiring the shared data using the capture function extension application 81 operating on the web browser 80, the controller 10 can suppress deficiencies such as deterioration in the quality of the shared data. The projection application 91 can capture the shared data without having a function of acquiring the shared data.

In the control flow, it is preferable to cause the capture function extension application 81 to transfer the shared data to the first projection system 100a via the stream distribution path SP different from the TCP/IP communication path TP.

By transferring the shared data through the stream distribution path SP, the controller 10 can suppress deterioration of the shared data at the time when the shared data is transmitted to the first projection system 100a.

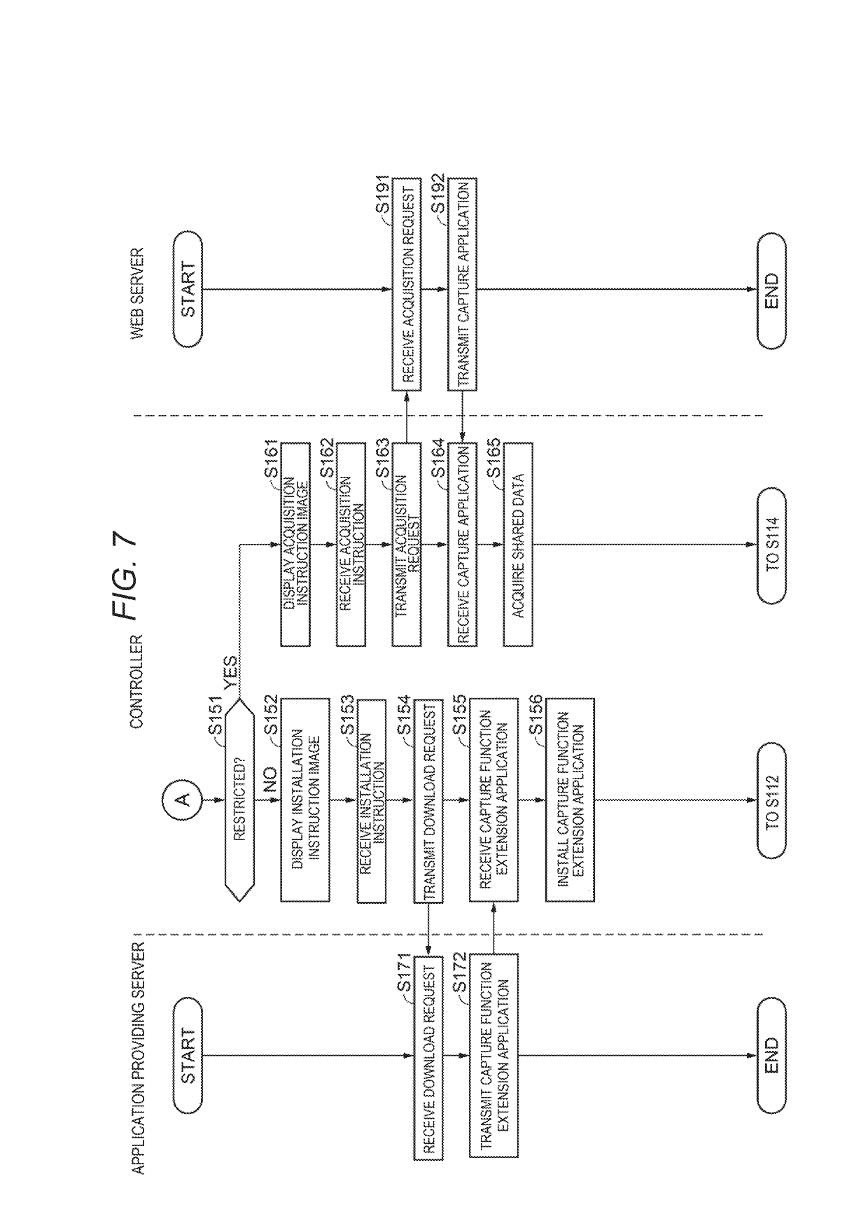

FIG. 7 illustrates a control flow executed by the system 1. FIG. 7 illustrates a control flow executed by the first system 1a, which is an example of the system 1. FIG. 7 illustrates a control flow in the case in which the capture function extension application 81 is not stored in the storage unit 40 in step S111 in FIG. 6 (step S111; NO). FIG. 7 illustrates a control flow of the process A illustrated in FIG. 6.

In step S151, the controller 10 discriminates whether installation of a function extension application is restricted. The installation restriction of the function extension application is set in advance by an administrator of the controller 10. Information concerning the configured installation restriction is stored in the storage unit 40. The browser controller 31 of the controller 10 discriminates, based on the information concerning the configured installation restriction, whether installation of the function extension application is restricted. When discriminating that the installation of the function extension application is not restricted, the browser controller 31 proceeds to step S152 (step S151: NO). When discriminating that the installation of the function extension application is restricted, the browser controller 31 proceeds to step S161 (step S151: YES).

When discriminating that the installation of the function extension application is not restricted, in step S152, the controller 10 causes the display 15 to display an installation instruction image 180. When the installation of the function extension application is not restricted, the user can install various function extension applications including the capture function extension application 81 in the controller 10. By causing the display 15 to display the installation instruction image 180, the controller 10 urges the user to install the capture function extension application 81.

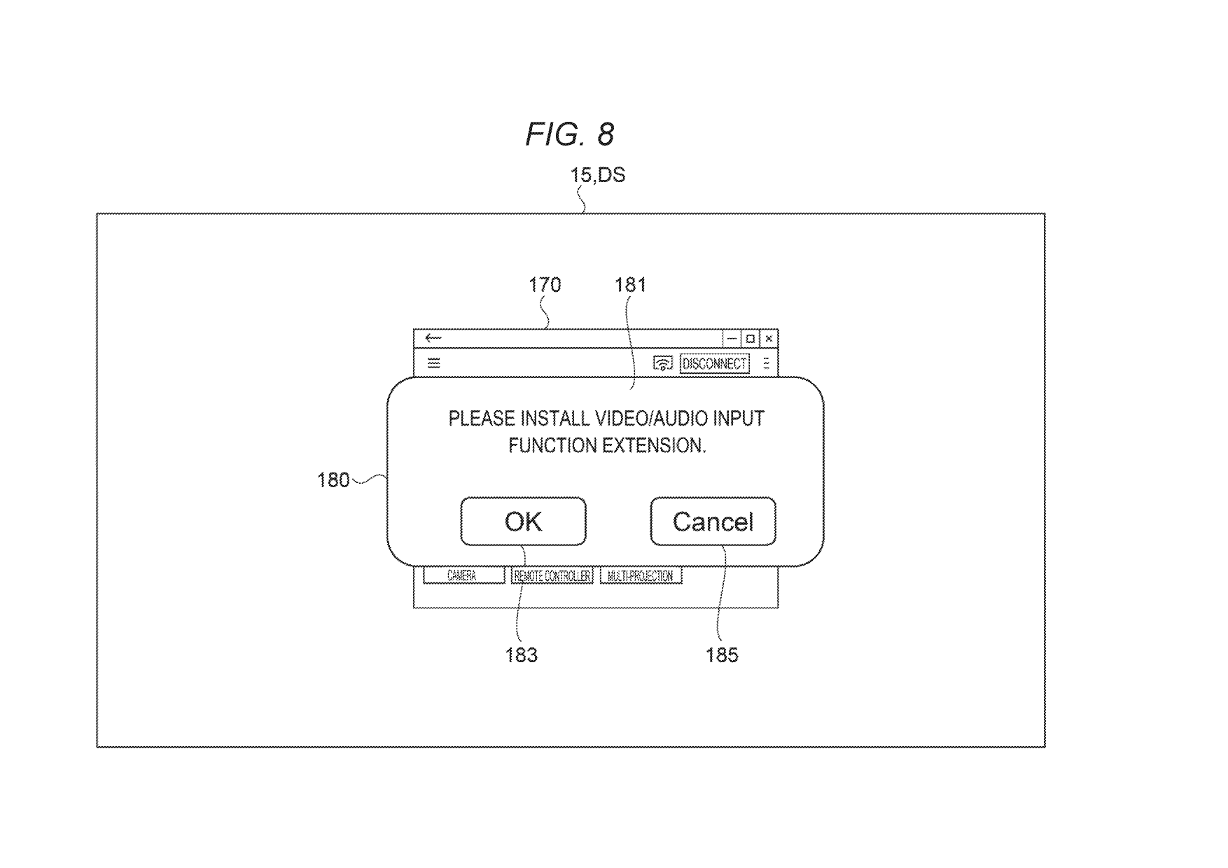

FIG. 8 illustrates an example of the installation instruction image 180. The installation instruction image 180 is displayed on the display 15. The installation instruction image 180 is displayed in the display screen DS. The installation instruction image 180 illustrated in FIG. 8 is displayed on the UI screen 170 by the web browser 80 but is not limited thereto. The installation instruction image 180 may be displayed at a position not overlapping the UI screen 170. When the installation instruction image 180 is displayed in the display screen DS, the UI screen 170 may not be displayed.

The installation instruction image 180 includes, for example, an installation instruction message 181, an installation permission icon 183, and an installation cancel icon 185. The installation instruction image 180 may include a message other than the installation instruction message 181.

The installation instruction message 181 indicates an instruction for causing the user to install the capture function extension application 81. In the installation instruction message 181 illustrated in FIG. 8, the capture function extension application 81 is illustrated as video/audio input function extension. The installation instruction message 181 corresponds to an example of an installation instruction indication. By visually recognizing the installation instruction message 181, the user can grasp that the user is requested to install the capture function extension application 81.

The installation permission icon 183 receives an installation instruction by the user. The installation instruction is an instruction indicating a request to cause the controller 10 to install the capture function extension application 81. When the user performs predetermined operation on the installation permission icon 183, the controller 10 receives the installation instruction.

The installation cancel icon 185 receives an installation non-permission instruction from the user. The installation non-permission instruction is an instruction indicating that it is not permitted to cause the controller 10 to install the capture function extension application 81. When the user performs predetermined operation on the installation cancel icon 185, the controller 10 receives the installation non-permission instruction. The controller 10 ends the processing without installing the capture function extension application 81.

After causing the display 15 to display the installation instruction image 180 in step S152 illustrated in FIG. 7, the controller 10 receives the installation instruction in step S153. When the user performs predetermined operation on the installation permission icon 183, the controller 10 receives the installation instruction.

After receiving the installation instruction, in step S154, the controller 10 transmits a download request to the application providing server 300. The download request is a signal for requesting download of the capture function extension application 81. The controller 10 stores a server address of the application providing server 300 in advance. The acquisition controller 35 of the control unit 30 transmits the download request to the server address.

When the controller 10 transmits the download request, in step S171, the application providing server 300 receives the download request. The application providing server 300 receives the download request transmitted by the acquisition controller 35.

When receiving the download request, in step S172, the application providing server 300 transmits the capture function extension application 81 to the controller 10. The application providing server 300 transmits the capture function extension application 81 to the communication unit 50 of the controller 10 in response to the download request.

When the application providing server 300 transmits the capture function extension application 81, in step S155, the controller 10 receives the capture function extension application 81. The communication unit 50 receives the capture function extension application 81. The acquisition controller 35 acquires the capture function extension application 81 via the communication unit 50.

After receiving the capture function extension application 81, the controller 10 installs the capture function extension application 81 in step S156. By installing the capture function extension application 81, the controller 10 can cause the web browser 80 to capture generation data and acquire the generation data as shared data. After installing the capture function extension application 81, the controller 10 proceeds to step S112 illustrated in FIG. 6.

When discriminating that the installation of the function extension application is restricted, in step S161, the controller 10 causes the display 15 to display an acquisition instruction image 190. When the installation of the function extension application is restricted, the user cannot install various function extension applications including the capture function extension application 81 in the controller 10. The controller 10 causes the display 15 to display the acquisition instruction image 190 to thereby urge the user to acquire the capture application 83 having the same function as the function of the capture function extension application 81.

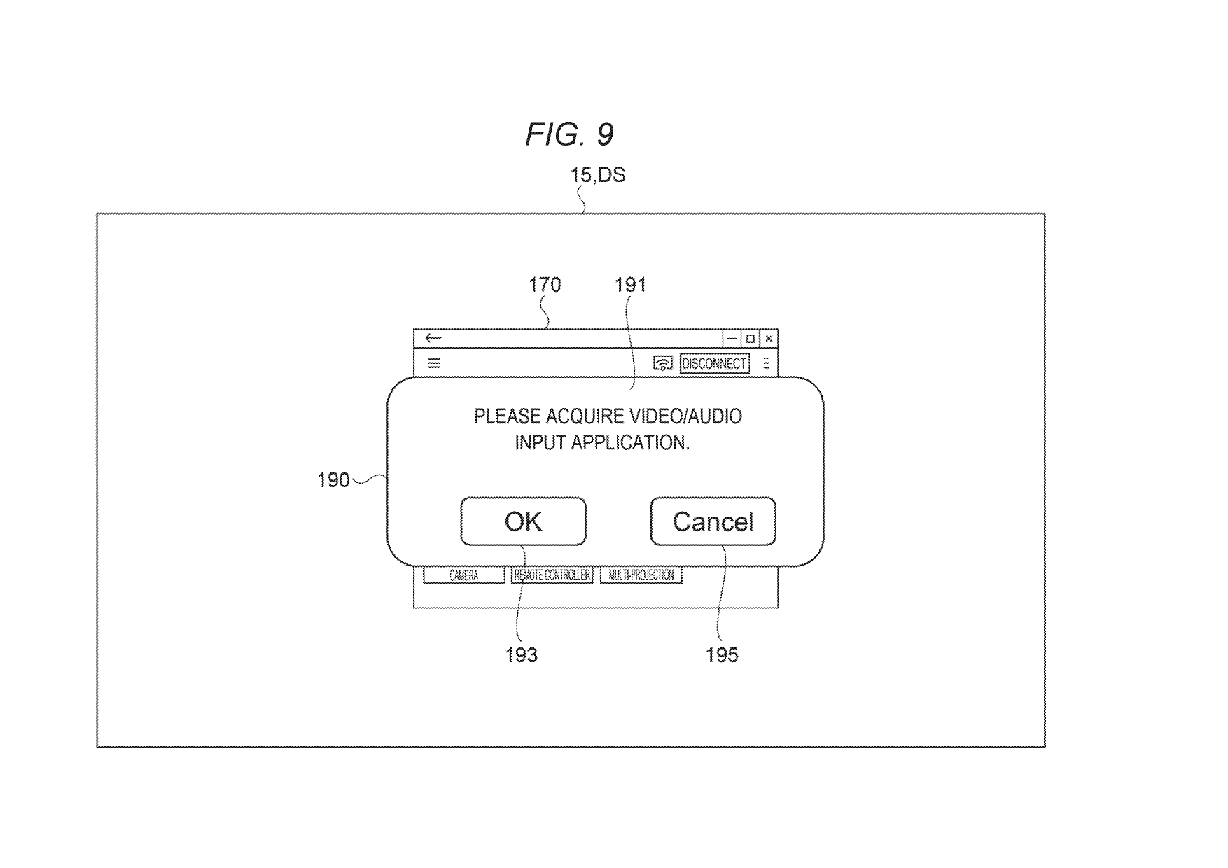

FIG. 9 illustrates an example of the acquisition instruction image 190. The acquisition instruction image 190 is displayed on the display 15. The acquisition instruction image 190 is displayed in the display screen DS. The acquisition instruction image 190 illustrated in FIG. 9 is displayed on the UI screen 170 but is not limited thereto. The acquisition instruction image 190 may be displayed at a position not overlapping the UI screen 170. When the acquisition instruction image 190 is displayed in the display screen DS, the UI screen 170 may not be displayed.

The acquisition instruction image 190 includes, for example, an acquisition instruction message 191, an acquisition permission icon 193, and an acquisition cancel icon 195. The acquisition instruction image 190 may include a message and the like other than the acquisition instruction message 191.

The acquisition instruction message 191 indicates an instruction to cause the user to acquire the capture application 83. The acquisition instruction message 191 illustrated in FIG. 9 illustrates the capture application 83 as a video/audio input application. The acquisition instruction message 191 corresponds to an example of an acquisition instruction indication. By visually recognizing the acquisition instruction message 191, the user can grasp that the user is requested to acquire the capture application 83.

The acquisition permission icon 193 receives an acquisition instruction by the user. The acquisition instruction is an instruction indicating a request to cause the controller 10 to acquire the capture application 83. When the user performs predetermined operation on the acquisition permission icon 193, the controller 10 receives the acquisition instruction.

The acquisition cancel icon 195 receives an acquisition non-permission instruction by the user. The acquisition non-permission instruction is an instruction indicating that it is not permitted to cause the controller 10 to acquire the capture application 83. When the user performs predetermined operation on the acquisition cancel icon 195, the controller 10 receives the acquisition non-permission instruction. The controller 10 ends the processing without acquiring the capture application 83.

After causing the display 15 to display the acquisition instruction image 190 in step S161 illustrated in FIG. 7, in step S162, the controller 10 receives an acquisition instruction. When the user performs predetermined operation on the acquisition permission icon 193, the controller 10 receives the acquisition instruction.

After receiving the acquisition instruction, in step S163, the controller 10 transmits an acquisition request to the web server 400. The acquisition request is a signal for requesting acquisition of the capture application 83. The controller 10 stores, in advance, in the storage unit 40, an address of a web page on which the capture application 83 operates. The address of the web page on which the capture application 83 operates is stored in the storage unit 40 when the projection application 91 is installed in the controller 10. The acquisition controller 35 of the control unit 30 requests acquisition of the capture application 83 by accessing the address of the web page on which the capture application 83 operates.

When the controller 10 transmits the acquisition request, the web server 400 receives the acquisition request in step S191. The web server 400 receives the acquisition request transmitted by the acquisition controller 35.

When receiving the acquisition request, in step S192, the web server 400 transmits the capture application 83 to the controller 10. The web server 400 transmits, in response to the acquisition request, to the communication unit 50 of the controller 10, the web page on which the capture application 83 operates. The web server 400 transmits the capture application 83 to the communication unit 50 by transmitting the web page on which the capture application 83 operates.

When the web server 400 transmits the capture application 83, the controller 10 receives the capture application 83 in step S164. The communication unit 50 receives the capture application 83. The acquisition controller 35 acquires the capture application 83 via the communication unit 50.

After receiving the capture application 83, in step S165, the controller 10 acquires shared data. The web browser 80 starts the capture application 83 and causes the capture application 83 to acquire the shared data. The capture application 83 captures, as capture data, generation data output from the output unit 20 of the controller 10. The generation data includes at least one of the video data output from the display data outputter 21 and the audio data output from the sound outputter 23. The capture data is an example of shared data including at least one of video data and audio data.

After acquiring the shared data, the controller 10 proceeds to step S112 illustrated in FIG. 6.

The control flow executed by the controller 10 includes, when the capture function extension application 81 is not stored in the storage unit 40, displaying the installation instruction message 181 for causing the controller 10 to install the capture function extension application 81, receiving an installation instruction to cause the controller 10 to install the capture function extension application 81, acquiring the capture function extension application 81, and installing the capture function extension application 81.

When the capture function extension application 81 is not stored in advance, in response to a capture request, the controller 10 can cause the capture function extension application 81 to function.

The control flow executed by the controller 10 includes, when the capture function extension application 81 is not stored in the storage unit 40, displaying the acquisition instruction message 191 for urging acquisition of the capture application 83 operating on the web browser 80, receiving an acquisition instruction for the capture application 83, starting the capture application 83 on the web browser 80, and causing the capture application 83 to acquire shared data.

When installation of a function extension application is restricted, the controller 10 can acquire the shared data using the capture application 83.

The control flow executed by the controller 10 preferably includes causing the capture application 83 to transfer the shared data to the first projection system 100a via the stream communication path SP different from the TCP/IP communication path TP.

The controller 10 can transfer the shared data to the first projection system 100a using the capture application 83.

### Second Embodiment

In a second embodiment, a second system 1b, which is an example of the system 1, is explained. The second system 1b includes a second projection system 100b that does not include the stream communicator 151 that performs communication using the WebRTC technology. The second projection system 100b is an example of the projection system 100.

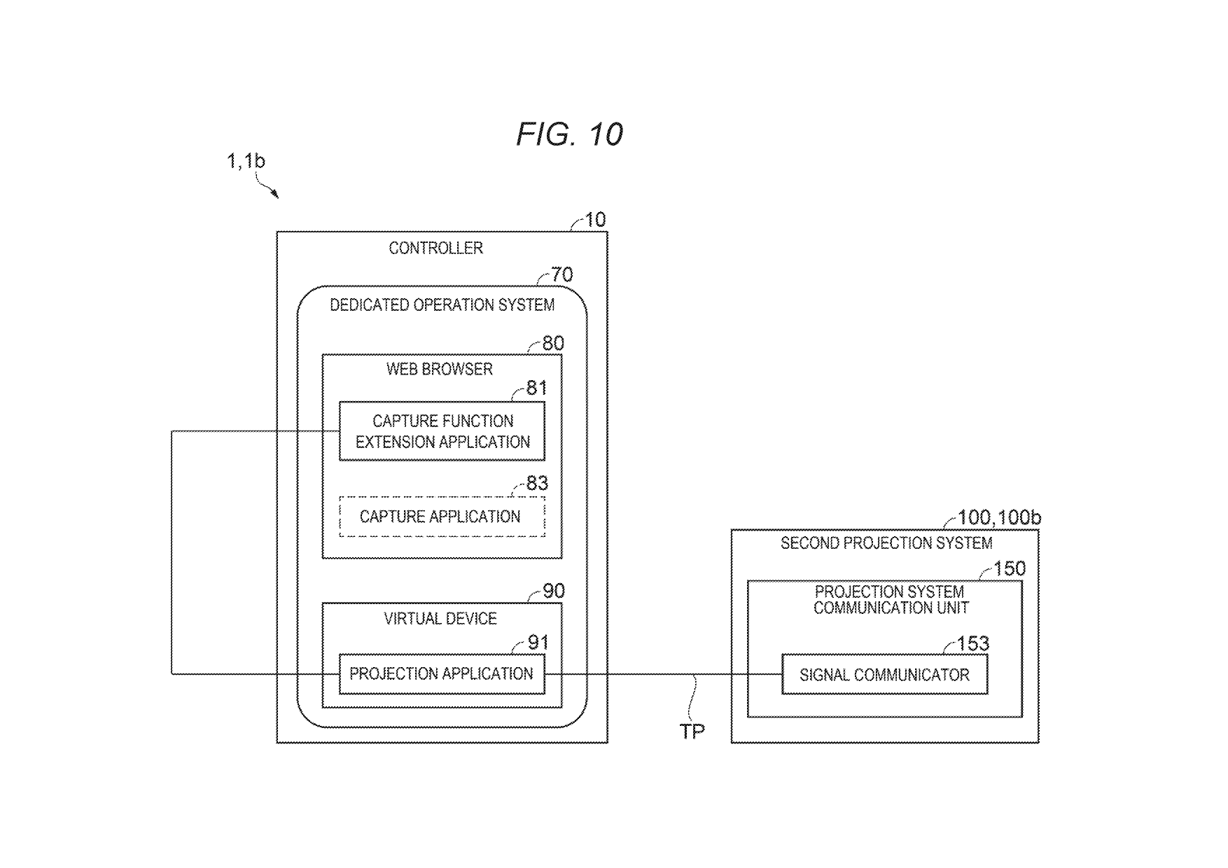

FIG. 10 illustrates a system configuration of the system 1. FIG. 10 schematically illustrates a system configuration of the second system 1b, which is an example of the system 1. FIG. 10 illustrates the controller 10 and the second projection system 100b.

The controller 10 illustrated in FIG. 10 has the same configuration as the configuration of the controller 10 illustrated in FIG. 4. The second projection system 100b illustrated in FIG. 10 does not include the stream communicator 151. The controller 10 and the second projection system 100b are not communicably connected via the stream distribution path SP and are communicably connected via the TCP/IP communication path TP. The controller 10 transmits shared data to the second projection system 100b via the TCP/IP communication path TP.

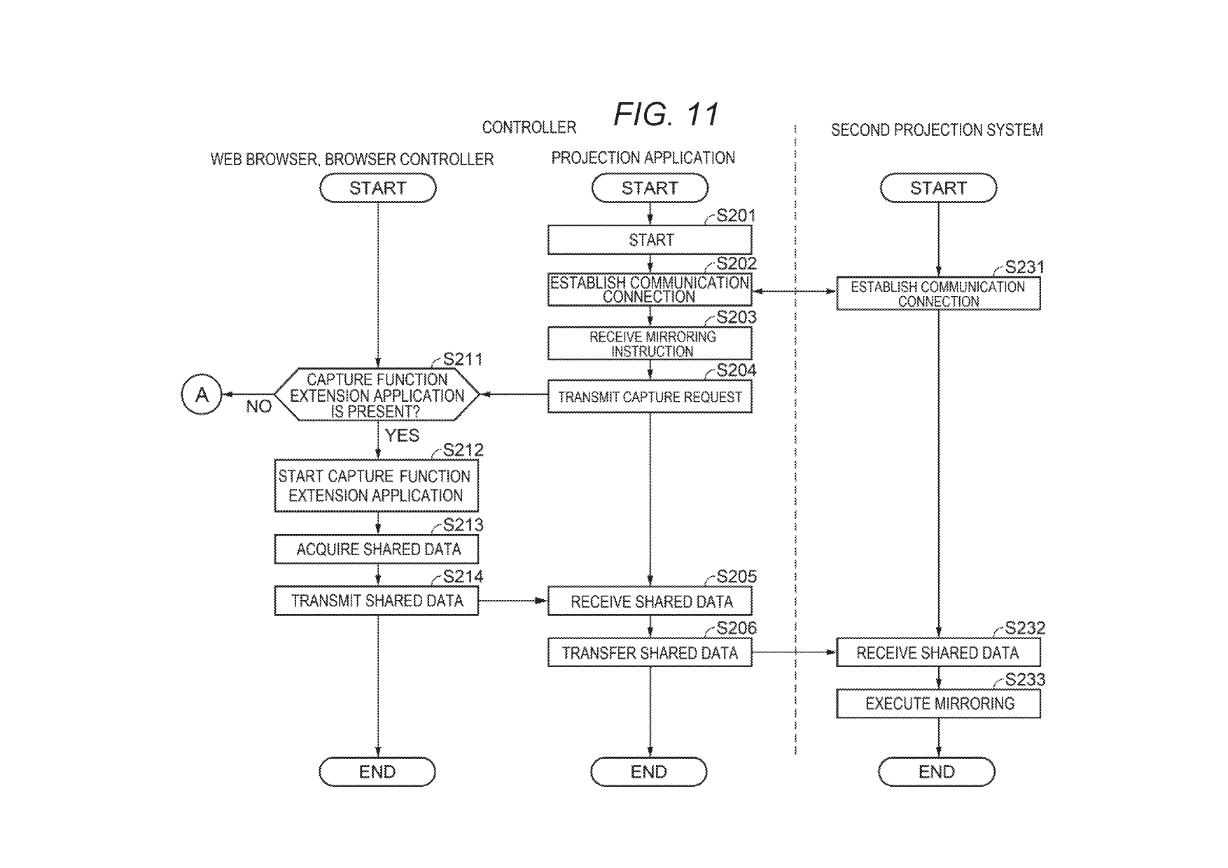

FIG. 11 illustrates a control flow executed by the system 1. FIG. 11 illustrates a control flow executed by the second system 1b, which is an example of the system 1. FIG. 11 illustrates a control flow executed by the controller 10 and the second projection system 100b. The controller 10 executes the control flow to thereby execute mirroring for causing the second projection system 100b to project the display screen DS displayed on the display 15.

In step S201, the controller 10 starts the projection application 91. When receiving predetermined operation by the user, the controller 10 starts the projection application 91. The projection application 91 starts on the virtual device 90. The projection application 91 is executed on a virtual environment.

After starting the projection application 91, in step S202, the controller 10 establishes communication connection to the second projection system 100b. The projection application 91 transmits a control signal such as a connection request to the second projection system 100b through the TCP/IP communication path TP and establishes communication connection to the second projection system 100b.

After the projection application 91 is started, in step S231, the second projection system 100b establishes communication connection to the projection application 91. The second projection system 100b receives a control signal such as a connection request from the projection application 91 through the TCP/IP communication path TP. The second projection system 100b transmits various data such as model information and establishes communication connection to the projection application 91. When the communication connection to the projection application 91 is established, the second projection system 100b can receive the shared data transferred from the controller 10.

After establishing the communication connection to the second projection system 100b, the controller 10 receives the mirroring instruction in step S203. When started, the projection application 91 causes the display 15 to display the UI screen 170. When the user executes predetermined operation on the mirroring reception icon 172 included in the UI screen 170 displayed on the display 15, the mirroring reception icon 172 receives the mirroring instruction. When receiving the mirroring instruction, the projection application 91 generates various control signals such as a mirroring control signal corresponding to the mirroring instruction.

After receiving the mirroring instruction, in step S204, the projection application 91 transmits a capture request corresponding to the mirroring instruction to the browser controller 31. The browser controller 31 receives the capture request.

After the projection application 91 transmits the mirroring request, in step S211, the browser controller 31 discriminates whether the capture function extension application 81 is stored in the storage unit 40. When discriminating that the capture function extension application 81 is not stored in the storage unit 40, the browser controller 31 proceeds to the process A illustrated in FIG. 7 (S211: NO). When discriminating that the capture function extension application 81 is stored in the storage unit 40, the browser controller 31 proceeds to step S212 (S211: YES).

In step S212, the browser controller 31 starts the capture function extension application 81. When receiving the capture request, the browser controller 31 discriminates whether the web browser 80 is started. When the web browser 80 is not started, the browser controller 31 starts the web browser 80. After starting the web browser 80, the browser controller 31 starts the capture function extension application 81. When the capture function extension application 81 is started, the web browser 80 can acquire, with the function of the capture function extension application 81, as shared data, generation data output from the output unit 20.

After executing the capture function extension application 81, the controller 10 acquires the shared data in step S213. The web browser 80 causes the capture function extension application 81 to acquire the shared data. The capture function extension application 81 captures, as capture data, generation data output from the output unit 20 of the controller 10. The generation data includes at least one of the video data output from the display data outputter 21 and the audio data output from the sound outputter 23. The capture data is an example of shared data including at least one of video data and audio data.

When the shared data is acquired, in step S214, the controller 10 transmits the shared data to the projection application 91. Since the controller 10 and the second projection system 100b do not form the stream distribution path SP, the capture function extension application 81 cannot directly transfer the shared data to the second projection system 100b. The capture function extension application 81 transmits the shared data to the projection application 91 to thereby cause the projection application 91 to transfer the shared data to the second projection system 100b.

After the web browser 80 acquires the shared data, in step S205, the projection application 91 receives the shared data. The projection application 91 receives the shared data transmitted by the capture function extension application 81.

After receiving the shared data, in step S206, the projection application 91 transfers the shared data to the second projection system 100b. The projection application 91 transfers the shared data to the second projection system 100b via the TCP/IP communication path TP.

When the controller 10 transfers the shared data, in step S232, the second projection system 100b receives the shared data. The signal communicator 153 of the projection system communication unit 150 receives the shared data via the TCP/IP communication path TP.

After receiving the shared data, in step S233, the second projection system 100b executes mirroring. When the video data is included in the shared data, the second projection system 100b acquires the video data included in the shared data. The projection controller 131 of the projection system control unit 130 transmits the video data to the projector 110. The projection controller 131 causes the projector 110 to project the video data. The projector 110 projects the projection image PG based on the video data onto the projection surface SC. When the audio data is included in the shared data, the second projection system 100b acquires the audio data included in the shared data. The projection controller 131 transmits the audio data to the projection system built-in speaker 120. The projection system built-in speaker 120 outputs sound based on the audio data. The second projection system 100b displays, based on the shared data including the video data and the audio data, the display screen DS displayed on the display 15 of the controller 10, and outputs sound based on the audio data. When the shared data is the audio data, the projection controller 131 of the projection system control unit 130 transmits the audio data to the projection system built-in speaker 120. The second projection system 100b outputs sound based on the audio data. The second projection system 100b executes mirroring based on the shared data including one of the video data and the audio data.

The control flow executed by the controller 10 includes causing the projection application 91 to acquire the shared data acquired by the capture function extension application 81 and causing the projection application 91 to transfer the shared data to the second projection system 100b via the TCP/IP communication path TP.

The controller 10 can transmit the shared data to the second projection system 100b not adapted to the WebRTC technology.

A summary of the present disclosure is appended below.

### Appendix 1

A method including: communicatively connecting to a projection device; causing an application program to transmit a control signal for controlling the projection device to the projection device via a signal communication path; and causing a web browser extension program functioning on a web browser to acquire output data including at least one of video data and audio data.

By providing the method that includes acquiring the output data using the web browser extension program operating on the web browser, the information processing apparatus can suppress deficiencies such as deterioration in the quality of the output data. Without having a function of acquiring the output data, the application program can cause the web browser extension program to acquire the output data.

### Appendix 2

The method described in Appendix 1 includes causing the web browser extension program to transfer the output data to the projection device via a browser communication path different from the signal communication path.

By causing the web browser extension program to transmit the output data through the browser communication path, the information processing apparatus can suppress deterioration of the output data at the time when the output data is transmitted to the projection device.

### Appendix 3

The method described in Appendix 1 includes: causing the application program to acquire the output data acquired by the web browser extension program; and causing the application program to transfer the output data to the projection device via the signal communication path.

By providing the method, the information processing apparatus can transmit the output data to a projection device not adapted to the WebRTC technology.

### Appendix 4

The method described in any one of Appendixes 1 to 3 includes: when the web browser extension program is not stored in a storage unit, displaying an installation instruction indication for causing the method to install the web browser extension program; receiving an installation instruction for causing the method to install the web browser extension program; acquiring the web browser extension program; and installing the web browser extension program.

By providing the method, the information processing apparatus can cause the web browser extension program to function in response to the installation instruction when the web browser extension program is not stored in advance.

### Appendix 5

The method described in any one of Appendixes 1 to 3 includes: when the web browser extension program is not stored in a storage unit, displaying an acquisition instruction indication for urging acquisition of a web application program operating on the web browser; receiving an acquisition instruction for the web application program; starting the web application program on the web browser; and causing the web application program to acquire the output data.

By providing the method, the information processing apparatus can acquire shared data using the web application program when the installation of the web browser extension program is restricted.

### Appendix 6

The method described in Appendix 5 includes causing the web application program to transfer the output data to the projection device via a browser communication path different from the signal communication path.

By providing the method, the information processing apparatus can transfer the output data to the projection device using the web application program.

What is claimed is:

1. A method comprising:
communicatively connecting to a projection device;
causing an application program to transmit a control signal for controlling the projection device to the projection device via a signal communication path; and
causing a web browser extension program functioning on a web browser to acquire output data including at least one of video data and audio data.

2. The method according to claim 1, further comprising causing the web browser extension program to transfer the output data to the projection device via a browser communication path different from the signal communication path.

3. The method according to claim 1 further comprising:
causing the application program to acquire the output data acquired by the web browser extension program; and
causing the application program to transfer the output data to the projection device via the signal communication path.

4. The method according to claim 1, further comprising:
when the web browser extension program is not stored in a storage unit,
displaying an installation instruction indication for causing the method to install the web browser extension program;
receiving an installation instruction for causing the method to install the web browser extension program;
acquiring the web browser extension program; and
installing the web browser extension program.

5. The method according to claim 1, further comprising:
when the web browser extension program is not stored in a storage unit,
displaying an acquisition instruction indication for urging acquisition of a web application program operating on the web browser;
receiving an acquisition instruction for the web application program;
starting the web application program on the web browser; and
causing the web application program to acquire the output data.

6. The method according to claim 5, further comprising causing the web application program to transfer the output data to the projection device via a browser communication path different from the signal communication path.
